(19) United States
(12) Patent Application Publication
(10) Pub. No.: US 2006/0121298 A1
(43) Pub. Date: Jun. 8, 2006

(54) Carrier device for a biological preparation which can be cut by means of laser micro-dissection

(75) Inventors: Werner Wittke, Braunfels (DE); Christian May, Marburg (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Leica Microsystems Wetzlar GmbH, Wetzlar (DE)

(21) Appl. No.: 10/523,330

(22) PCT Filed: Jul. 2, 2003
(86) PCT No.: PCT/EP03/07054

§ 371 Date: Jan. 28, 2005

(30) Foreign Application Priority Data
Jul. 30, 2002 (DE) 102 34 755.7

(51) Int. Cl. B32B 27/36

(52) U.S. Cl. 428/480

(57) ABSTRACT

A carrier device for a biological preparation cuttable by laser microdissection includes a frame-like holder having the substantial form of a petri dish with an open bottom, and a laser light-absorbing film located on the frame-like holder so as to cover the opening.

The present invention relates to a carrier device for a biological preparation which can be cut by laser microdissection and which is located on a freely suspended, laser light-absorbing film mounted on a frame-like holder.

In the field of biology and medicine, “microdissection” refers to a method by which a small piece is cut out from a generally flat preparation (for example, cells or a tissue sections) using a fine, focused laser beam. The piece cut out is thus available for further biological or medical (for example, histological) analyses. The preparative method used depends, inter alia, on the laser microdissection method intended to be used for processing the preparation.

German document DE 201 00 866.1 discloses a carrier device for a preparation, in particular a biological preparation; the preparation being provided for the purpose of cutting out a preparation region using a focused laser beam. The carrier device has a laser light-absorbing and therefore laser-cuttable film for receiving the preparation; the film being mounted on a frame-like holder so that it is freely suspended and therefore not supported or carried by any other carrier means below the film. The carrier device for a preparation is specifically designed for use in a laser microdissection method in which the cutting, focused laser beam is directed onto the preparation from above, and the preparation region cut out falls down after the cutting operation.

Such a method was already described in the article “Cell surgery by laser micro-dissection: a preparative method”, by G. Isenberg, W. Bielser, W. Meier-Ruge, E. Remy, Journal of Microscopy, Vol. 107, May 1976, pages 19-24. In that method, a focused laser beam of a pulsed UV laser is directed onto a preferably biological preparation from above, and a preparation region of interest is encircled with the focused laser beam along a complete cut line. In this manner, the preparation region of interest is completely separated from the area and surrounding it falls down into a collecting device.

German Patent Application DE 100 39 979 A1 discloses a carrier device and a laser microdissection method for separating a preparation region of interest from a living biological preparation; the preparation region of interest being cut out by a laser beam producing a cut line. The living preparation is placed on a laser-cuttable film that is supported by a carrier means. After completing the cut line, the preparation region cut out along with a portion of the film remains on the carrier means before it is then catapulted upwards into a collecting device by a further laser pulse additionally needed. Since the nutrient liquid above the preparation hinders the catapulting process, it is generally necessary to decant the nutrient liquid prior to catapulting, which significantly reduces the survival time of the living preparation.

A more recent method and device for laser microdissection is described in German document DE 100 43 506. In that method, a focused laser beam is directed onto a preferably biological preparation from above. In a first step, a preparation region of interest is encircled with the focused laser beam along an incomplete cut line largely enclosing the preparation region of interest such that there remains between a beginning and end of the cut line a stable web by way of which the preparation region of interest is joined to the surrounding sample. In a second step, the web is severed with a single focused laser pulse directed onto it after the cut width has been adjusted, i.e., enlarged to the width of the web. The preparation region of interest is completely detached from its surrounding area with the last cutting laser pulse and falls down. This method has the advantage over the aforementioned method that it prevents the nearly severed preparation region from folding away or rotating out of position towards the end of the cutting operation.

Previous fields of application of laser microdissection included cell selection from histological sections, for example, in molecular pathology, cell biology, or in neuro-research. However, users increasingly wish to select cells also from a culture or aggregate of living cells. For the cell culture, the above-mentioned carrier devices must therefore be placed in a petri dish. Subsequently, the films of the carrier devices are wetted or coated with culture medium and the desired cells are seeded thereon. After the cells have grown, the carrier devices are removed from the petri dish and placed in a device for laser microdissection, such as disclosed in German document DE 100 43 506.

This method has the disadvantage that the cells can only be kept alive for a short period of time after the carrier device is removed from the petri dish. Moreover, the film of the carrier devices can be damaged during handling. In addition, the laser microdissection device may become contaminated because the carrier device comes into contact with culture medium also in the region of its frame or underside so that cells can settle there as well. Therefore, in the examination of pathogens, this presents not only a handling problem but also a hygienic problem.

It is therefore the object of the present invention to provide a carrier device which makes it possible to perform laser microdissection on living cell cultures in a user-friendly and hygienic manner, in particular using a laser beam directed onto the preparation from above.

This objective is achieved by a carrier device for a biological preparation which can be cut by laser microdissection and which is located on a freely suspended, laser light-absorbing film mounted on a frame-like holder; the carrier device being characterized according to the present invention in that the frame-like holder is substantially in the form of a wall of a petri dish whose bottom is completely or partially omitted, and in that the missing bottom is replaced exclusively by the laser light-absorbing film.

The carrier device of the present invention has the advantage that the carrier device is itself used to preculture the cells, which makes preculture of cells easier. After preculture, the cells are maintained under optimized, reliable growth conditions, even during laser microdissection. The handling problem is eliminated because, unlike in methods known heretofore, it is no longer necessary to remove the cell cultures from the petri dish. Moreover, it is impossible for the device used for laser microdissection to become contaminated.

The carrier device can be embodied in different ways. Thus, for example, the entire bottom of the petri dish can be formed by the laser light-absorbing film. However, it is also conceivable that the laser light-absorbing film forms only part of the bottom of the petri dish. Thus, for example, the wall of the petri dish as well as an edge region of the bottom can be made of plastic, and only a remaining opening in the petri dish bottom is closed by the film. It is crucial that the film, first of all, absorb laser light, i.e., can be cut by laser and, secondly, that the film be strong enough not to sag in the area of the covered bottom opening and to carry the culture medium together with the cells. Therefore, the film must be selected to have a sufficient thickness.

Therefore, a polyethylene naphtalate film (PEN), preferably having a thickness of 1.35 μm or 2.5 μm, has proven suitable for the laser light-absorbing film of the carrier device. However, depending on the application, other film thicknesses can also be used.

The connection between the wall of the petri dish and the laser light-absorbing film can be accomplished in different ways. Thus, for example, the laser light-absorbing film can be welded to the bottom edge of the wall of the petri dish or to the edge area of the opening in the bottom of the petri dish.

An economical solution is to adhesively bond together the wall of the petri dish and the laser light-absorbing film. This bonding can be accomplished using an adhesive tape. For this purpose, the adhesive tape is designed, preferably in the form of a template, in such a manner that the adhesive tape is bonded on one side to the wall of the petri dish and, on the other side, to the laser light-absorbing film.

In a different embodiment of the connection between the wall of the petri dish and the laser light-absorbing film, the film can already be applied to ring-shaped holding members in a preliminary process; i.e., using welding or adhesive bonding techniques. The diameter of the ring-shaped holding members is matched to the cylindrical wall of the petri dish. The ring-shaped holding members have snap-in grooves into which the wall of the petri dish can snap in, resulting in a liquid-tight releasable connection between the wall of the petri dish and the ring-shaped holding member provided with the laser-cuttable film bottom. This embodiment has the advantage that the ring-shaped holding member with the laser-cuttable film bottom can later be removed from the wall of the petri dish so that the cell culture can either be further processed or, for example, archived or frozen in a space-saving manner.

For handling in the laboratory, it proves convenient to make the laser light-absorbing film hydrophilic, because this makes it easier to apply a cell culture medium to the laser-cuttable film. The nutrient medium that is usually used is a nutrient liquid. Nutrient media for the cell culture are commercially available, such as DMEM (Dulbeco's Modified Eagle's Medium) or RPMI (Rosewell Park Memorial Institute Medium) or MEM.

Depending on the size of preparation regions cut out, the nutrient liquid can seep through the microscopically small holes that form in the laser-cuttable film during laser microdissection. Therefore, it turns out to be particularly convenient if the nutrient medium is in the form of a nutrient gel which is sufficiently rigid or, at least, very viscous so that it remains at rest around the holes made in the laser-cuttable film by laser microdissection.

Separation of the desired preparation region can be accomplished by encircling the preparation region of interest with the focused laser beam along a complete cut line. After the preparation region of interest has been completely separated from its surrounding area by the laser beam, it falls down and can be collected in a collecting device.

In an alternative cutting method, a preparation region of interest is encircled with the focused laser beam along an incomplete cut line largely enclosing a preparation region of interest. In this case, there remains between a beginning and end of the cut line a stable web by way of which the preparation region of interest is joined to the surrounding sample. In a second step, the web is severed with a single focused laser pulse directed onto it; the cut width of the laser pulse being adjusted to the web. In this manner, the preparation region of interest is completely separated from its surrounding area and falls down.

The carrier device according to the present invention allows the use of a method for laser microdissection of living biological cell cultures, in which a focused laser beam is directed onto a living biological preparation from above. In this method, the cells are treated particularly gently and carefully because they fall by gravity into a collecting vessel. This eliminates the need for a mechanical or laser-induced cell transport involving the risk of damaging the cells.

Fields of application include the selection of preferably living cells or organisms from pure or mixed cultures to subject them to further analysis or culture. Thus, it is possible, for example, to separate cancer cells from an aggregation of healthy cells, stained cells from cultures, microorganisms from mixed cultures (or cultures), or parasites from cultures.

Advantageous embodiments of the present invention will be described below with reference to the schematic drawing, in which

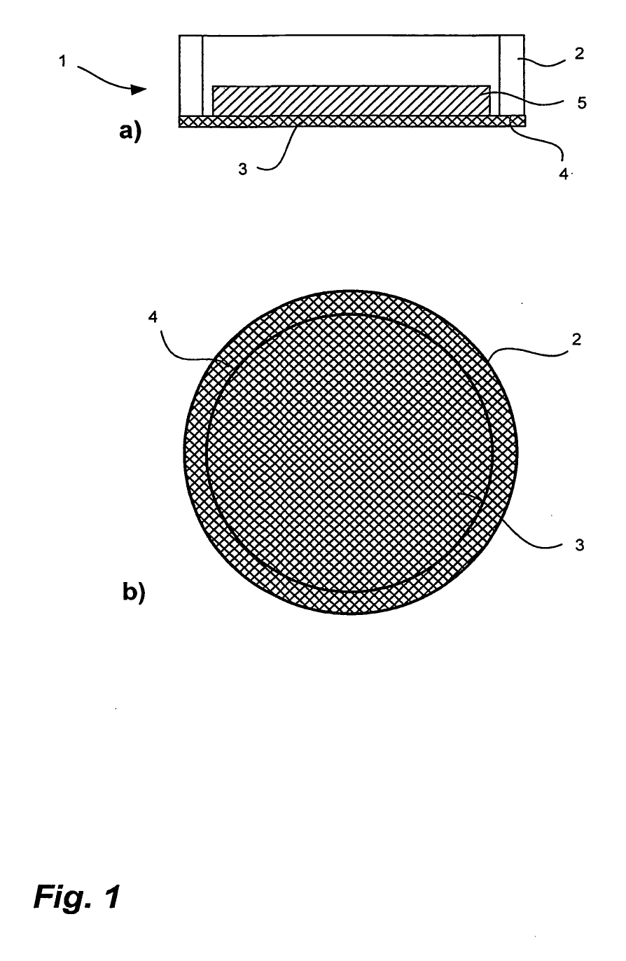

FIG. 1 shows a first embodiment of a carrier device having a film bottom extending over the entire bottom area;

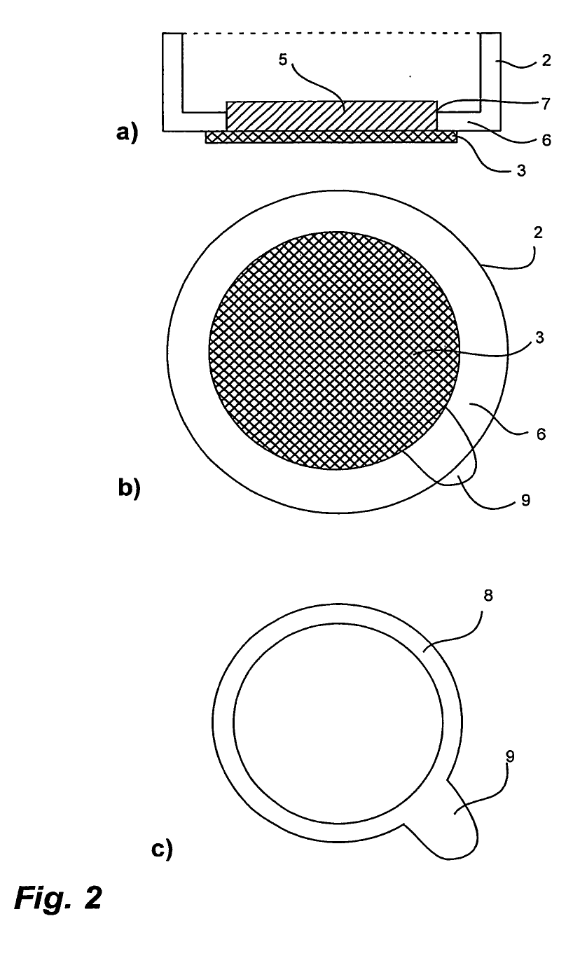

FIG. 2 shows a second embodiment of a carrier device whose film bottom does not extend over the entire bottom area;

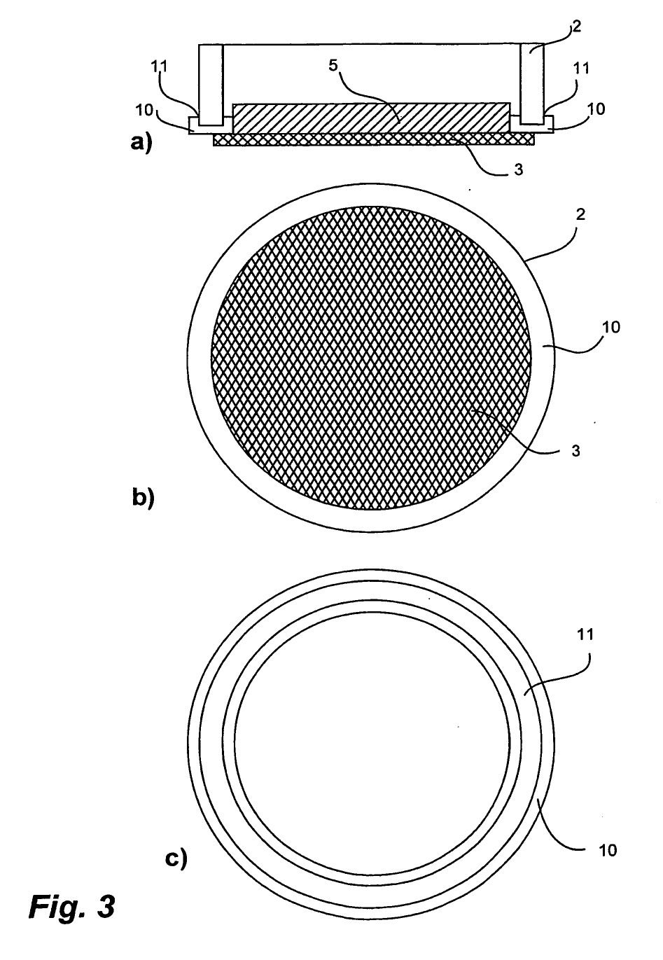

FIG. 3 depicts a third embodiment of a carrier device having a reversibly attachable film bottom extending over the entire bottom area;

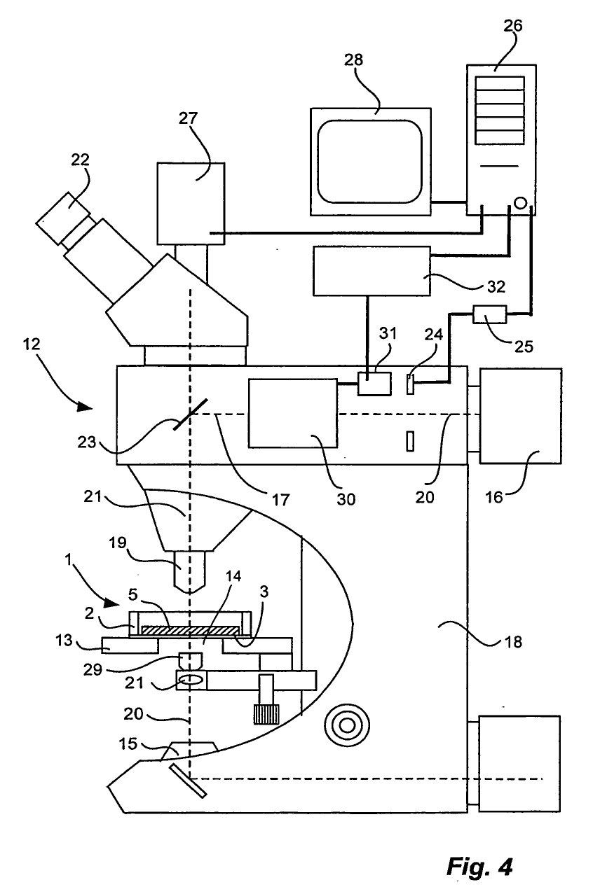

FIG. 4 illustrates a device for laser microdissection featuring a carrier device which has a film bottom extending over the entire bottom area.

FIG. 1 shows a first embodiment of a carrier device 1 having a film bottom extending over the entire bottom area. FIG. 1a is a vertical sectional view of carrier device 1 while FIG. 1b is a bottom view of carrier device 1.

Carrier device 1 has a frame-like holder in the form of a wall 2 of a petri dish, which is typically made of plastic. The petri dish has no bottom. The missing bottom of the petri dish is replaced by a laser light-absorbing and therefore laser-cuttable film 3, which is adhesively bonded to the bottom edge 4 of wall 2. The adhesive is applied in only a thin layer and is therefore not shown. It is crucial that the adhesive bond be resistant to a nutrient solution or a viscous nutrient gel to be applied later for the cell culture to be grown. Moreover, it must be ensured that the adhesive is not cytotoxic in order to prevent damage to the biological preparation.

The absorption of laser-cuttable film 3 is matched to the wavelength of the laser intended for cutting; a pulsed UV laser being preferably used for laser microdissection. Therefore, the use of a polyethylene naphtalate film (PEN), preferably having a thickness of 1.35 μm or 2.5 μm, has proven suitable for laser light-absorbing film (3) of carrier device (1). However, depending on the application, other film thicknesses can also be used.

In order to allow problem-free cutting with the focused laser beam at a later time, the film must be applied in such a manner that it is exactly plane and does not become corrugated. It is only in this way that, once the focus of the laser beam is adjusted, the film can be cut at different locations by simply moving the laser beam and the carrier device relative to each other, making it possible to make a complete cut line.

A biological preparation 5 is placed on laser-cuttable film 3. The present example concerns a living biological preparation. This preparation was obtained by wetting or coating laser-cuttable film 3 of carrier device 1 with culture medium. The desired cells were seeded thereon. In this context, it is crucial that laser-cuttable film 3 have a thickness sufficient to carry the preparation and the culture medium without sagging. It is only in this way that the plane film 3 can later be accurately cut at only one focus setting of the laser beam, as described above. The growth of the cell culture formed the preparation 5. Now, carrier device 1 can be inserted into a laser microdissection device along with preparation 5, i.e., the cell culture.

FIG. 2 shows a second embodiment of a carrier device 1 whose film bottom does not extend over the entire bottom area. FIG. 2a is vertical sectional view of carrier device 1. Carrier device 1 has a frame-like holder which is in the form of a wall 2 of a petri dish and, in addition, forms an outer annular portion 6 of the petri dish bottom.

FIG. 2b is a bottom view of carrier device 1. This view clearly shows that the petri dish does not have a closed bottom. Instead, there is only an outer annular portion 6 of the petri dish bottom, the annular portion enclosing a clear opening 7. Opening 7 is covered, and thus closed, by a laser light-absorbing and therefore laser-cuttable film 3, which is adhesively bonded to the underside of annular portion 6 of the petri dish bottom. Thus, laser-cuttable film 3 replaces the missing bottom of the petri dish. In the present example, bonding is accomplished with a suitably shaped adhesive film 8.

FIG. 2c is a top view of an embodiment of this suitably shaped adhesive film 8. The adhesive film is preformed in the form of a template in such a manner that it completely encloses clear opening 7. A small tab 9 makes handling easier.

Adhesive film 8 can preferably be a double-sided adhesive tape including an insoluble carrier with adhesive applied to both sides thereof; the adhesive in each case being covered on the outside with a cover film. After removing the first cover film, the adhesive tape can be placed with the exposed adhesive at the desired location on the underside of annular portion 6 of the petri dish bottom.

After that, the second cover film is also removed so that the adhesive tape remains with its carrier at annular portion 6 of the bottom. Then, laser-cuttable film 3 can be placed on the exposed adhesive of the adhesive tape and bonded thereto. Alternatively, the adhesive film 8 used can also be a rigid film of adhesive applied between two strong cover films. After removing the first cover film, the film of adhesive can be placed at the desired location on the underside of annular portion 6 of the petri dish bottom. After that, the second cover film is also removed so that only the film of adhesive remains at annular portion 6 of the bottom. Then, laser-cuttable film 3 can be placed on the film of adhesive and bonded thereto.

For all bonds, it is crucial that the adhesive bond be resistant to a nutrient solution or a viscous nutrient gel to be applied later for the cell culture to be grown. Moreover, the adhesive bond must withstand the weight of film 3, the nutrient medium and the cell culture. Moreover, it must be ensured that the adhesive film is not cytotoxic in order to avoid damage to the biological preparation.

FIG. 3 depicts a further embodiment of a carrier device 1 having a reversibly attachable film bottom extending over the entire bottom area. FIG. 3a is vertical sectional view of carrier device 1. Carrier device 1 has a frame-like holder which is in the form of a wall 2 of a petri dish. The petri dish has no bottom. The missing bottom of the petri dish is replaced by a laser light-absorbing and therefore laser-cuttable film 3.

Unlike in the exemplary embodiment of FIG. 1, laser-cuttable film 3 is not bonded directly to the bottom edge of wall 2. Instead, the carrier device has an additional, ring-shaped holding member 10 to the underside of which is bonded laser-cuttable film 3. Ring-shaped holding member 10 is provided on its upper side with a peripheral snap-in groove 11 into which is snap-fitted the bottom edge of wall 2 of the petri dish. For that purpose, the diameters of ring-shaped holding member 10 and snap-in groove 11 are matched to the cylindrical wall of the petri dish.

FIG. 3b is a bottom view of carrier device 1, showing ring-shaped holding member 10 with laser-cuttable film 3 bonded to the underside thereof. Bonding can be accomplished by one of the methods described with reference to FIG. 1 and FIG. 2.

FIG. 3c is a top view of ring-shaped holding member 10, showing peripheral snap-in groove 11 provided on the upper side thereof. The snap connection is liquid-tight so that laser-cuttable film 3 can be covered with liquid nutrient medium without liquid passing through the snap connection. The snap connection at the same time provides a releasable connection between wall 2 of the petri dish and ring-shaped holding member 10 provided with laser-cuttable film 3. This embodiment has the advantage that ring-shaped holding member 10 provided with laser-cuttable film 3 can later be removed from wall 2 of the petri dish.

FIG. 4 depicts a device for laser microdissection with a carrier device 1 according to the present invention. During cutting, the laser microdissection device moves a laser beam across a preparation secured relative thereto. The laser microdissection device includes a microscope 12 having a microscope stand 18 and a motor-driven X/Y stage 13 used for holding carrier device 1.

Carrier device 1 has a frame-like holder in the form of a wall 2 of a petri dish, which is typically made of plastic. The petri dish has no bottom. The missing bottom of the petri dish is replaced by a laser light-absorbing and therefore laser-cuttable film 3, which is adhesively bonded to the bottom edge 4 of wall 2. The adhesive is applied in only a thin layer and is therefore not shown. A living biological preparation 5 is placed or already grown on laser light-absorbing and therefore laser-cuttable film 3. To be able to illuminate preparation 5 from below, X/Y stage 13 is provided with a frame-like stage opening 15.

The microscope 12 shown is a transmitted light microscope. For that purpose, an illumination system 15 and a condenser 21 illuminating sample 4 are arranged below X/Y stage 13 and thus also underneath preparation 5. Below preparation 5, there is located at least one collection container 29 for collecting the severed preparation region of interest. The light passing through preparation 5 reaches objective 19 of microscope 12. Inside microscope 12, the light is directed via lenses and mirrors (not shown) to at least one eyepiece 22 through which a user can observe preparation 5 located on X/Y stage 13.

A laser 16, in this example a UV laser, emits a laser beam 17 which is coupled into an incident illumination beam path having an optical axis 20. A laser scanning device 30 is arranged in the illumination beam path. Laser beam 17 passes through laser scanning device 30 and, via an optical system 23, reaches an objective 19 which focuses laser beam 17 onto preparation 5. Optical system 23 is preferably designed as a dichromatic beam splitter through which an imaging beam path originating at preparation 5 passes through objective 19 to at least one eyepiece 22. Alternatively, optical system 23 can be comprised of a plurality of optical components. This is the case, for example, if laser beam 17 must be deflected several times.

Also provided in laser beam 17 is an aperture stop 24 which allows adjustment of the diameter of laser beam 17. Aperture stop 24 can, for example, be a fixed aperture. In an advantageous embodiment, a plurality of fixed apertures can be provided on a turret plate or a linear slide for placing one of these fixed apertures in the optical path as the aperture stop 24 specifically needed. Insertion into laser beam 17 is done by the user manually or by a motor.

In this embodiment, the adjustment of laser scanning device 30, and thus the alignment of laser beam 17 onto preparation 5, is accomplished by a motor 31 associated with laser scanning device 30, a control unit 32, and a computer 26. Motor 31 is connected to control unit 32 which provides the control signals for controlling motor 31. Control unit 32 is connected to computer 26 to which is connected a monitor 28. Monitor 28 displays the image of preparation 5 recorded by camera 27. The system including computer 26, camera 27 and monitor 28 is used to observe and monitor the cutting process. Thus, the computer can deliver trigger signals to the laser for triggering laser pulses and for controlling the laser power, and control aperture motor 25 as well as an auto-focus device (not shown) for laser 16. For that purpose, computer 26 is connected to laser 16 to which it delivers trigger signals for triggering laser pulses when a cutting operation is performed.

Using a computer mouse (not shown) or any other cursor control device, the sample region of interest to be cut out of preparation 5 is encircled on monitor 28 with the aid of a mouse pointer. In this manner, a desired cut line is defined in the camera image on monitor 28.

Laser scanning device 30 itself is used as a cut line control unit by which laser beam 17, which is focused onto biological preparation 5, is moved across the fixed biological preparation 5. X/Y stage 13 is not moved horizontally, i.e., in the X- or Y-direction, for that purpose.

The focusing of laser beam 17 onto biological preparation 5 can be done by a user by manually adjusting the height of X/Y stage 13 while, at the same time, visually monitoring the camera image. However, an embodiment of the device which includes an auto-focus device (not shown) for laser beam 17 is more user-friendly.

Through control of laser scanning device 30, laser beam 17 can be moved to arbitrary positions on preparation 5. During the entire preparation of the cut and also during the cutting process itself, biological preparation 5 can be kept alive because the growth conditions in carrier device 1 are maintained at all times.

By suitably controlling laser scanning device 30, focused laser beam 17 is moved across preparation 5, thus producing a complete cut line around the preparation region of interest. The preparation region of interest itself is at no time irradiated by the laser beam so that a damaging effect of the laser radiation on the preparation region of interest is impossible. After completing the cut line, the preparation region of interest is completely separated from the remaining preparation 5 surrounding it, and falls by gravity into collection container 29 located underneath.

### List of Reference Numerals

1. carrier device
2. wall of the petri dish
3. laser-cuttable film
4. bottom edge of wall 2
5. biological preparation
6. annular portion
7. opening
8. adhesive film
9. tab
10. ring-shaped holding member
11. snap-in groove
12. microscope
13. moving X/Y stage
14. frame-like stage opening
15. illumination system
16. laser
17. laser beam
18. microscope stand
19. objective
20. optical axis
21. condenser
22. eyepiece
23. optical system
24. aperture stop
25. aperture motor
26. computer
27. camera
28. monitor
29. collection container
30. laser scanning device
31. motor for the laser scanning device
32. control unit

1-14. (canceled)

15. A carrier device for a biological preparation cuttable by laser microdissection, the carrier device comprising:
a frame-like holder having a substantial form of a petri dish with an opening at a bottom thereof; and
a laser light-absorbing film disposed on the frame-like holder so as to cover the opening.

16. The carrier device as recited in claim 1 wherein the opening is coextensive with an entire bottom of the petri dish form so that the laser light-absorbing film forms the entire bottom.

17. The carrier device as recited in claim 1 wherein the laser light-absorbing film includes a polyethylene naphtalate film.

18. The carrier device as recited in claim 17 wherein the polyethylene naphtalate film has a thickness of 1.35 μm or 2.5 μm.

19. The carrier device as recited in claim 1 wherein the laser light-absorbing film is weldedly attached to the frame-like holder.

20. The carrier device as recited in claim 1 wherein the laser light-absorbing film is adhesively bonded to the frame-like holder.

21. The carrier device as recited in claim 20 wherein the frame-like holder includes a cylindrical wall and further comprising an adhesive film having a form of a template so that the adhesive film is bonded on a first side to the cylindrical wall and on a second side to the laser light-absorbing film.

22. The carrier device as recited in claim 1 wherein the frame-like holder includes a cylindrical wall and ring-shaped holding member having the laser-cuttable film adhesively or weldedly bonded thereto, the ring-shaped holding member having a diameter matched to the cylindrical wall and including a snap-in groove configured to snapably receive the cylindrical wall in a liquid-tight releasable manner.

23. The carrier device as recited in claim 1 wherein the laser light-absorbing film is hydrophilic.

24. The carrier device as recited in claim 1 wherein the laser light-absorbing film is configured to receive a nutrient medium for cell culture.

25. The carrier device as recited in claim 24 wherein the nutrient medium includes a nutrient liquid.

26. The carrier device as recited in claim 24 wherein the nutrient medium includes a nutrient gel.

27. A method for laser microdissection of living biological cell cultures using a laser microdissection device, the method comprising:
providing a frame-like holder having a substantial form of a petri dish with an opening at a bottom thereof;
disposing a laser light-absorbing film on the frame-like holder so as to cover the opening; and
disposing a biological preparation including a living biological cell culture on the laser light-absorbing film; and
directing a cutting, focused laser beam through an objective onto the biological preparation so as to encircle a region of interest of the preparation by a complete cut line and separate the region of interest from a surrounding area of the preparation.

28. The method as recited in claim 27 wherein the directing is performed so as to direct the laser beam through the objective onto the biological preparation from above the biological preparation.

29. The method as recited in claim 27 wherein at least a portion of the laser light-absorbing film is freely suspended.

30. A method for separating a preparation region of interest from a living biological preparation, the method comprising:
providing a frame-like holder having a substantial form of a petri dish with an opening at a bottom thereof;
disposing a laser light-absorbing film on the frame-like holder so as to cover the opening;
disposing a biological preparation on the laser light-absorbing film; and
cutting out a preparation region of interest of the biological preparation by a laser beam forming a cut line so that the preparation region of interest falls into a collection container disposed underneath the biological preparation.

31. The method as recited in claim 30 wherein at least a portion of the laser light-absorbing film is freely suspended.

32. The method as recited in claim 15 wherein at least a portion of the laser light-absorbing film is freely suspended.
